(19) United States
(12) Patent Application Publication
(10) Pub. No.: US 2026/0129112 A1
(43) Pub. Date: May 7, 2026

(54) CASE FOR MOBILE DEVICE

(71) Applicant: Hamee Global Inc., Seoul (KR)

(72) Inventors: Bum Joon LEE, Seoul (KR); Kwang Min YUK, Seoul (KR)

(21) Appl. No.: 19/377,305

(22) Filed: Nov. 3, 2025

(30) Foreign Application Priority Data
Nov. 6, 2024 (KR) 20-2024-0001967

(51) Int. Cl. H04M 1/02

(52) U.S. Cl. CPC H04M 1/0203

(57) ABSTRACT

A case for a mobile device includes: a first body portion having a first insertion groove into which a portion of a mobile device is inserted; a second body portion, positioned separately from the first body portion, having a second insertion groove into which another portion of the mobile device is inserted; and a first connection portion including a first insertion plug detachably attached to a first side hole located on a first side of the first body portion and a second insertion plug detachably attached to a second side hole located on a first side of the second body portion, and a first connection plug connecting the first insertion plug and the second insertion plug.

### CROSS-REFERENCE TO RELATED APPLICATION

This application claims the benefit of Korean Patent Application No. 20-2024-0001967, filed on November 06, 2024, in the Korean Intellectual Property Office, the disclosure of which is incorporated herein in its entirety by reference.

### BACKGROUND

### 1. Field

The present disclosure relates to a case for a mobile device, comprising a connecting portion that connects a first body portion and a second body portion at a distance from each other, and characterized in that the first and second body portions are rotatable through the bendable connecting portion.

### 2. Description of the Related Art

Mobile devices, including smartphones, are widely used across all age groups and are electronic devices that are closely intertwined with our daily lives. Beyond making phone calls, mobile devices can be used for a variety of tasks. A widely used feature, beyond phone calls and text messaging, is the camera, and camera functionality continues to improve. Meanwhile, recent mobile devices, even smartphones, have reached a point where they can perform almost the same functions as PCs. With the recent development of foldable displays, foldable mobile devices with two foldable bodies are becoming widespread.

These mobile devices are often expensive and are typically used with cases to protect them from shock and damage.

Furthermore, cases with various features are being proposed to enhance user convenience.

### SUMMARY

According to one or more embodiments, a mobile device case comprises: a first body portion having a first insertion groove into which a portion of the mobile device is inserted; a second body portion separated from the first body portion and having a second insertion groove into which another portion of the mobile device is inserted; The device may include a first connecting portion, including a first insertion plug detachable from a first side hole located on a first side of the first body portion and a second insertion plug detachable from a second side hole located on a first side of the second body portion, and a first connecting plug connecting the first insertion plug and the second insertion plug.

However, these are merely examples, and one or more embodiments are not limited thereto.

Additional aspects will be set forth in part in the description which follows and, in part, will be apparent from the description, or may be learned by practice of the presented embodiments of the disclosure. According to one or more embodiments, the first connecting plug has a C-shape, tapering toward the center, and is bendable by the center portion.

According to one or more embodiments, the first connecting portion may be made of a synthetic resin material.

According to one or more embodiments, the first connecting portion connects the first body portion and the second body portion and allows the first and second body portions to rotate along a predetermined axis.

According to one or more embodiments, the first connecting portion joins the first body portion and the second body portion at a predetermined distance, and the distance may vary as the first and second body portions rotate. The predetermined axis may be located in the space between the first body portion and the second body portion.

According to one or more embodiments, the first body portion and the second body portion may rotate depending on the degree to which the first connection plug is bent.

According to one or more embodiments, the first connection plug may be made of an elastic material and may be bent and restored.

According to one or more embodiments, the first connection portion may be coupled through a first side hole located at one end of the first body portion and a second side hole located at one end of the second body portion.

According to one or more embodiments, the second connection portion may further include a third insertion plug detachable from the third side hole located at the second side of the first body portion and a fourth insertion plug detachable from the fourth side hole located at the second side of the second body portion, and a second connection plug connecting the third insertion plug and the fourth insertion plug. Other aspects, features, and advantages beyond those described above will become apparent from the following drawings, claims, and detailed description of the invention.

Other aspects, features, and advantages in addition to those described above will be apparent from the following detailed description, claims, and drawings.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a mobile device case according to embodiments of the present invention, and FIG. 2 is an exploded view of the mobile device case;

FIG. 3 is a front view of the first body portion;

FIG. 4 is a front view of the second body portion;

FIG. 5 is a plan view of the mobile device case;

FIG. 6 is a bottom view of the mobile device case;

FIG. 7 is a diagram illustrating the mobile device case according to embodiments of the present invention in a folded state;

FIG. 8 is a perspective view of the first and second connecting portions;

FIG. 9 is a front view of the first connecting portion;

FIG. 10 is a rear view of the first connecting portion;

FIG. 11 is a side view of the first connecting portion.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term "and/or" includes any and all combinations of one or more of the associated listed items. Expressions such as "at least one of," when preceding a list of elements, modify the entire list of elements and do not modify the individual elements of the list.

Hereinafter, the configuration and operation of the present disclosure will be described in detail with reference to embodiments of the present disclosure shown in the accompanying drawings.

While example embodiments are capable of various modifications and alternative forms, embodiments thereof are shown by way of example in the drawings and will herein be described in detail. The effects and features of the present disclosure and the accompanying methods thereof will become apparent from the following description of the embodiments, taken in conjunction with the accompanying drawings. However, the present disclosure is not limited to the embodiments described below, and may be embodied in various modes.

Hereinafter, embodiments of the present disclosure will be described in detail with reference to the accompanying drawings, and, when describing with reference to the drawings, the same or corresponding elements are given the same reference numerals and redundant descriptions thereof will be omitted.

In the following embodiments, the terms first, second, etc. may not be used in a limited sense but may be used to distinguish one element or component from another element or component.

The singular forms are intended to include the plural forms as well, unless the context clearly indicates otherwise.

The terms "comprises," "includes," "have," etc. when used herein, specify the presence of stated features, elements, and/or components, but do not preclude the presence or addition of one or more other features, elements, or components.

In the drawings, elements or components may be exaggerated or reduced in sizes thereof for convenience of description. For example, the size and thickness of each element or component shown in the drawings are arbitrarily shown for convenience of description, so the present disclosure is not necessarily limited to what is shown.

When a certain embodiment is capable of being implemented differently, a particular process order may be performed differently from the described order. For example, two processes described in succession may be performed substantially simultaneously or may be performed in an order opposite to the described order.

One or more embodiments aims to provide a mobile device case that safely protects the mobile device and prevents interference when the mobile device is folded and unfolded. One or more embodiments also aims to provide a mobile device case that maintains a close contact with the mobile device even when the mobile device is folded and unfolded by connecting the first and second bodies at a predetermined distance. One or more embodiments also aims to provide a mobile device case that is formed of an elastic material and has a thin central portion, allowing the case to deform and then return to its original shape.

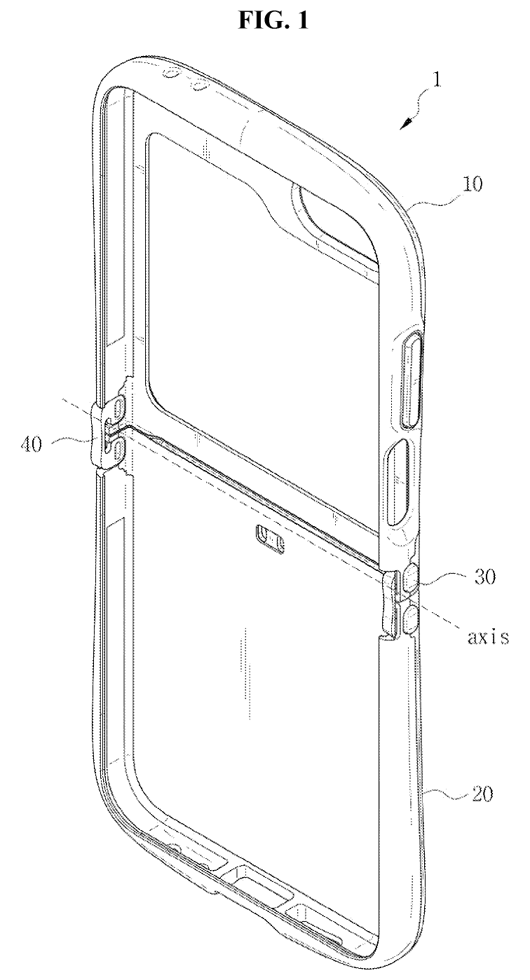

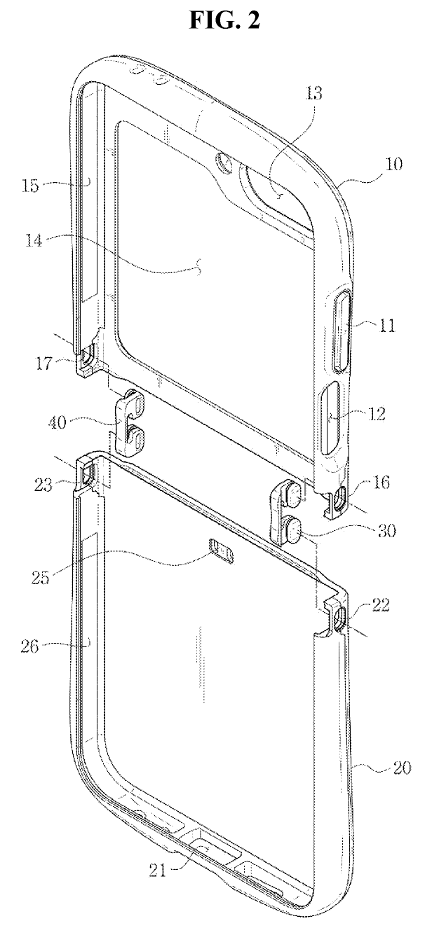

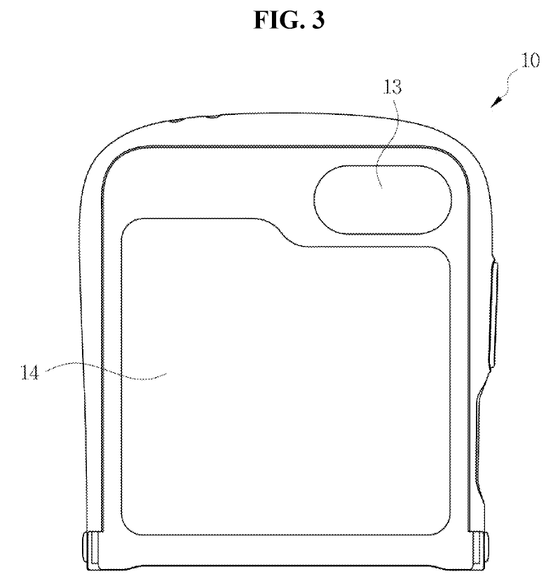

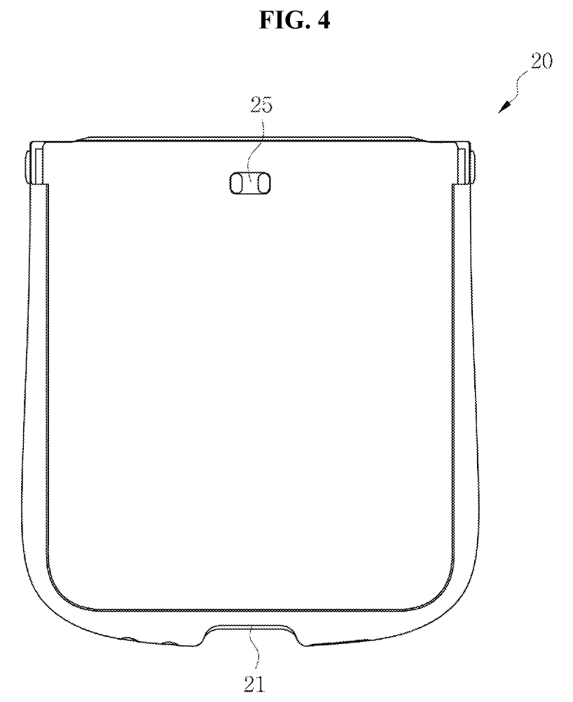

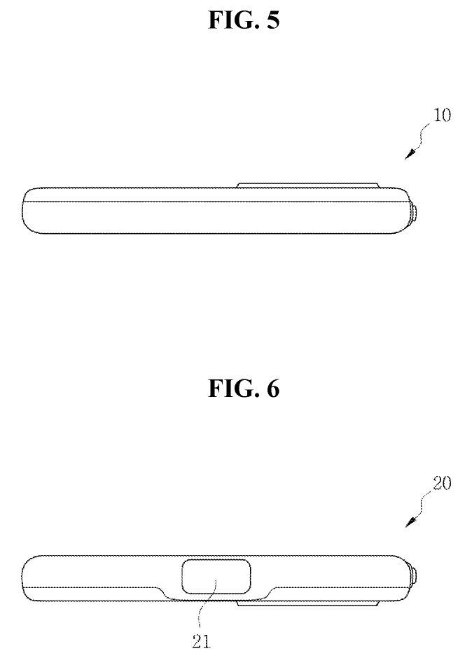

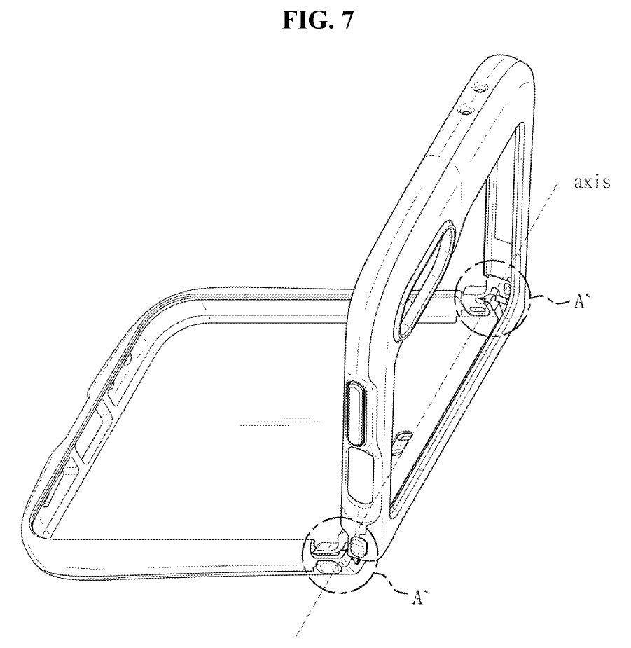

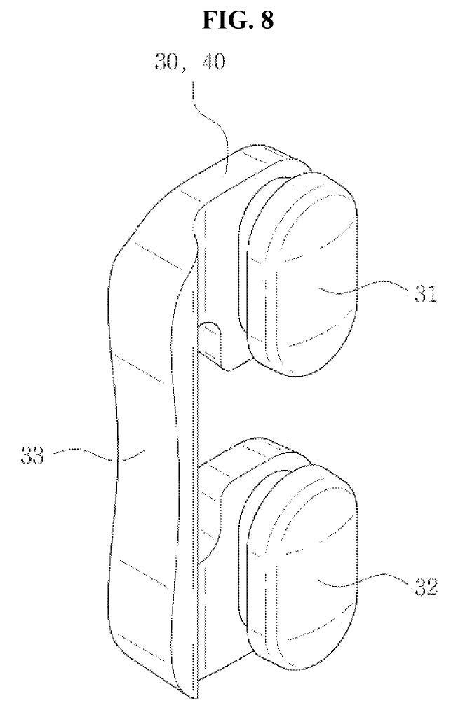

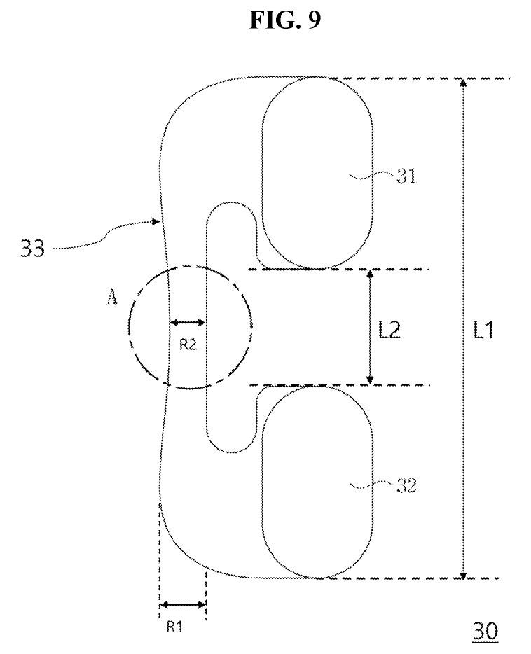

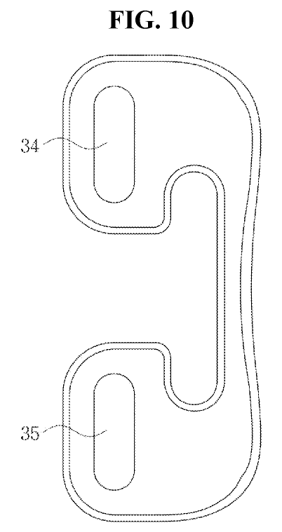

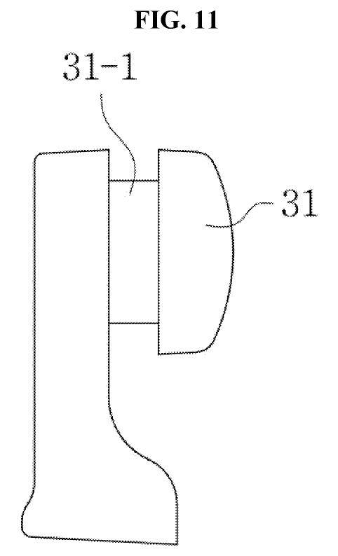

FIG. 1 is a perspective view of a mobile device case 1 according to one or more embodiments, and FIG. 2 is an exploded view of the mobile device case 1. FIG. 3 is a front view of the first body portion10. FIG. 4 is a front view of the second body portion20. FIG. 5 is a plan view of the mobile device case1, and FIG. 6 is a bottom view of the mobile device case1. FIG. 7 is a state diagram of the mobile device case1 according to one or more embodiments in a folded state. FIG. 8 is a perspective view of the first and second connecting portions30, 40, FIG. 9 is a front view of the first connecting portion, FIG. 10 is a rear view of the first connecting portion, and FIG. 11 is a side view of the first connecting portion.

Referring to FIGS. 1 to 11, a mobile device case1 according to one embodiment may be inserted into a folder-type mobile phone.

The mobile device case 1 may protect the folder-type mobile device from external impact. The mobile device case 1 may include a first body portion 10, a second body portion 20, and a first connection portion 30. The mobile device case1 may further include a second connection portion 40, thereby connecting the first body portion10 and the second body portion 20 through two connection portions 30, 40.

The first and second body portions 10, 20 may be formed of a flexible material (e.g., synthetic resin, silicone, rubber, polyurethane, neoprene, latex, etc.). Accordingly, the first and second body portions 10, 20 may be deformed by an external force and return to their original shape when the external force is removed. The first and second body portions 10, 20 may be formed of a material with a low degree of flexibility, such as plastic. The first and second body portions 10, 20 may be formed of a transparent material, but are not limited thereto and may be formed of an opaque or translucent material, etc. The surfaces of the first and second body portions 10, 20 may be formed to have various colors, patterns, and shapes. The surfaces of the first and second body portions 10, 20 may have unevenness, curves, or other three-dimensional shapes.

The first and second body portions 10, 20 may be formed to have plates, grooves, holes, etc., depending on the shape or form of the mobile device. In response to the camera included in the mobile device, a camera hole for the camera may be included in the first or second body portion 10, 20. The shape of the camera hole may correspond to the shape of the camera. The position of the camera hole may correspond to the position where the camera is placed. A button groove corresponding to a button included in a mobile device may be included in the first or second body portion 10, 20. The shape of the button groove may correspond to the shape of the button. The position of the button groove may be arranged at the location where the button is located.

A display hole 13, 14 may be included in the first or second body portion 10, 20 according to the location and shape of the display screen included in the mobile device. The shape of the display hole may correspond to the shape of the display screen. The location of the display hole may correspond to the position where the display screen is arranged.

A microphone hole may be included in the first or second body portion 10, 20 according to the location and shape of the microphone included in the mobile device. The shape of the microphone hole may correspond to the shape of the microphone. The location of the microphone hole may correspond to the position where the microphone is arranged. As illustrated in FIG. 5, the first body portion 10 may have a camera hole formed on the upper side depending on the shape of the mobile device. As illustrated in FIG. 6, the second body portion 20 may further include a charger hole 21 at the lower end for connection to an external charger. The second body portion 20 may further include an additional insertion groove 25, depending on the shape of the mobile device.

The first and/or second body portions 10, 20 may have a first insertion groove 15 and a second insertion groove 26 on the side portion for attachment to the mobile device. The first insertion groove15 and the second insertion groove26 may be formed to surround the housing of the mobile device and to surround the sidewall of the mobile device. The first insertion groove 15 may be designed to extend vertically from both edges of the plate of the first body portion 10 and thus be in close contact with the edge of the mobile device. The second insertion groove 26 may be designed to extend vertically from both edges of the plate of the second body portion 20 and thus be in close contact with the edge of the mobile device.

The mobile device case 1 may further include first and/or second connection portions 30, 40. As illustrated in FIG. 8, the first connection portion30 may include first and second insertion plugs 31, 32 that are respectively coupled to the first body portion 10 and the second body portion 20, and a first connecting plug 33 that connects the first and second insertion plugs 31, 32. The first connection portion 30 may be formed of an elastic material, and more specifically, may be a synthetic resin material. The first and second insertion plugs 31, 32 and the first connection plug 33 may be deformed in shape and/or form by an external force. The insertion plugs 31, 32 and/or the first connection plug 33 may be formed of various elastic materials, such as rubber, silicone, spring steel, polyurethane, neoprene, latex, and ethylene propylene diene monomer EPDM.

The first connection plug 33, as illustrated in FIG. 9, is formed in a C-shape, and first and second insertion plugs 31, 32 may be located to both ends. The first connection plug 33 may have a shape and/or form in which the central portion is thin. The first connection plug 33 may be formed to be flat corresponding to a first side where the first and second insertion plugs 31, 32 are arranged, and to be recessed inward corresponding to a second side located opposite the first side. The first connection plug 33 may be formed to be thicker in a portion other than the A portion(see FIG. 9), so that it may be bent at the A portion. The first connection plug 33 may be in the shape of a dumbbell with a thin center, but is not limited thereto and may have various shapes. The first connection plug 33 may be bent along the second side, as illustrated in FIG. 7 (A’, see FIG. 7).

As illustrated in FIG. 10, the first connecting portion 30 may have grooves 34, 35 on opposite planes of the surfaces from the first and second insertion plugs 31, 32 protrude. The grooves 34, 35 may have the same shape as the planar shapes of the first and second insertion plugs 31, 32.

As illustrated in FIG. 11, the first or second insertion plug 31, 32 of the first connecting portion 30 may have a flanged head shape and a tapered neck shape 31-1 and may be combined with a first side hole 16.

The second connecting portion 40 may be formed with the same structure as the first connecting portion 30 of FIG. 8.

As illustrated in FIG. 2, a first side hole 16 may be arranged at an end of one side of the first body portion 10, and a second side hole 22 may be arranged at an end of one side of the second body portion 20. The first insertion plug 31 may be coupled with the first side hole 16 of the first body portion 10, and the second insertion plug 32 may be coupled with the second side hole 22 of the second body portion 20. The first body portion 10 and the second body portion 20 may be coupled through the first connecting portion 30. The first body portion 10 and the second body portion 20 may form an integrated structure centered on the first connecting portion 30. Here, the coupling may be implemented in a method such as a fitting, a screw coupling, or an elastic engagement (snap-fit). Either the first connection portion 30 or the second connection portion 40 may be joined to the left or right side of the case for the mobile device.

The first connection portion 30 and/or the second connection portion 40 can be coupled with the first body portion 10 and the second body portion 20 before the mobile device is inserted into the first body portion 10 or the second body portion 20. The first connection portion 30 and/or the second connection portion 40 can be coupled with the corresponding side holes 16, 1722, 23 on the inside of the first body portion 10 and the second body portion 20. After the first body portion 10, the second body portion 20, and the first connection portion 30 are coupled, a mobile device can be inserted (see FIG. 8). When the mobile device is inserted into the case 1, the first insertion plug 31 and the second insertion plug 32 of the first connecting portion 30 can be hidden from being engaged with the side holes 16, 22. The engagement is done internally, and the appearance can be maintained as a seamless, unified form. After the mobile device is inserted, the first insertion plug 31 and the second insertion plug 32 can be prevented from being separated due to external impact, external force, etc., and the shock generated when the mobile device is dropped by the first connection portion 30 can be mitigated. The connection plug 33 of the first connection portion 30 may be structured to be exposed to the outside and protrude. The connection plug 33 can enable the first body portion 10 and the second body portion 20 to pivot or fold relative to each other. The connection plug 33 can function as a rotational axis around which the first and second body portions can rotate. The connection plug 33 can be designed as a hinge structure or a pivot structure. The connection plug 33 may allow the first body portion 10 and the second body portion 20 to fold, depending on the foldable mobile device. In the first body portion 10 and the second body portion 20, the thickness of the side surface where the side holes 16, 17, 22, 23 are located may be adjusted in accordance with the height of the insertion plugs 31, 32. The inner surface may be formed to be flat so that the mobile device can be inserted while the first or second connection portion 30, 40 is engaged. The first and second insertion plugs 31, 32 may have a non-circular shape so as not to rotate when coupled to the side holes 16, 22. The first and second insertion plugs 31, 32 may preferably be oval or D-shaped in plan view, but are not limited thereto and may have other shapes, such as rectangular or square.

The first side hole 16 and the second side hole 22 are positioned in the first body portion 10 and the second body portion 20, respectively, and may be formed to be positioned within a predetermined distance from the rotation axis when the mobile device case is worn.

The first side hole 16 and the first insertion plug 31 may be detached and attached. Each side hole and insertion plug may be coupled and detached for user convenience. Additional third side holes 17 and fourth side holes 23 are arranged in the first body portion 10 and second body portion 20, and the insertion plugs of the second connection portion 40 can be coupled to the third and fourth side holes 17, 23, respectively.

As illustrated in FIG. 7, after coupling, the first and second body portions 10, 20 rotate along an axis between the first and second body portions 10, 20. The axis of rotational movement can be located in the space between the first body portion 10 and the second body portion 20.

According to embodiments of the present invention, before inserting a mobile device into a mobile device case 1, each side hole and insertion plug may be coupled.

As illustrated in FIG. 9, the first connection portion 30 may include a connecting plug 33 connecting the first insertion plug 31 and the second insertion plug (32). The connecting plug 33 may include a bendable portion A that allows for bending and a fixed portion. The fixed portion may be fixed without bending when the first insertion plug 31 and the second insertion plug 32 are attached and connected to the mobile device.

The bendable portion A may be designed to have a relatively thin thickness R2. The thickness R2 of A may be 70 to 80% of the thickness R1 of the fixed portion. Preferably, R2 may be 1 to 2 mm. The thinner the thickness R2 of the bendable portion A, the easier it is to bend, but the risk of breakage may be reduced. R2 may be optimized to achieve a bending effect within the target bending angle range. The target bending angle range can be determined by considering the rotation range of the mobile device. A foldable mobile device can have a rotation range of 0 to 180 degrees. When the mobile device is fully unfolded, the connection plug 33 is fully extended. When the mobile device is fully folded, the bending portion A of the connection plug 33 can be fully folded.

The length L2 of the bending portion A may be 20 to 30% of the total length (L1) of the first connection portion 30. Preferably, the total length L1 of the first connection portion 30 may be 13 to 20 mm. If the length L2 of the bending portion A exceeds a predetermined maximum value, the risk of buckling under axial/torsional loads may increase. If the length L2 of the bending portion A falls below a predetermined minimum value, it may be difficult to meet the target bending angle range.

The present disclosure has been described with reference to the embodiments illustrated in the drawings, but the embodiments are merely illustrative. It will be understood by those skilled in the art that various modifications and other equivalent embodiments can be made from the embodiments. Hence, the real protective scope of the present disclosure should be determined on the basis of the accompanying claims.

The specific technical features described in the embodiments are merely examples and are not intended to limit the technical scopes of the embodiments. In order to concisely and clearly describe the disclosure, descriptions of general techniques and configurations according to the related art may be omitted. Also, the connecting lines or connecting members between the components illustrated in the drawings represent exemplary functional connections and/or physical or logical connections, and various alternative or additional functional connections, physical connections, or logical connections may be present in a practical device. Also, unless a specific term such as "essential" or "important" is mentioned for a component, the component may not be a necessary component for the application of the present disclosure.

The term "the" or similar references used in the detailed description and claims may cover both the singular and the plural unless specifically limited. Also, if a range is used in the embodiment, the embodiment may be regarded as including the inventive concept in which an individual value belonging to the range is applied (unless otherwise stated), and the individual values constituting the range are written in the detailed description. Unless the order of operations organizing a method according to an embodiment is explicitly mentioned or described otherwise, the operations may be performed in any suitable order. The embodiments are not necessarily limited to the mentioned order of the operations. The use of all examples or exemplary terms (e.g., "etc.", "and (or) the like", and "and so forth") in an embodiment is merely intended to describe the embodiment in detail, and the scope of the embodiment is not limited by the examples or exemplary terms unless defined by the claims. Also, it will be understood by those of ordinary skill in the art that the present disclosure can be made according to design conditions and factors within the range of the claims, in which various changes, combinations, and modifications are added, or an equivalent thereof.

The wearable device according to the embodiment may prevent the sweat, foreign substances, or the like generated from the outside or the skin of the user from flowing in the electrode, thereby preventing the degradation in the quality of signals measured by the electrode.

The wearable device according to the embodiment may prevent the impedance between the electrode and the skin or between the electrode and electrode from being reduced due to the sweat, foreign substances, or the like generated from the outside or the skin of the user, thereby enhancing the measurement precision.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A mobile device case comprising:
a first body portion having a first insertion groove into which a portion of a mobile device is inserted;
a second body portion, positioned separately from the first body portion, having a second insertion groove into which another portion of the mobile device is inserted; and
a first connection portion comprising a first insertion plug detachably attached to a first side hole located on a first side of the first body portion and a second insertion plug detachably attached to a second side hole located on a first side of the second body portion, and a first connection plug connecting the first insertion plug and the second insertion plug.

2. The mobile device case of claim 1, wherein:
the first connection plug has a C-shape, becomes thinner toward a center portion thereof, and is bent by the center portion.

3. The mobile device case of claim 1, wherein the first connection portion is made of a synthetic resin material.

4. The mobile device case of claim 1, wherein the first connection portion connects the first body portion and the second body portion and allows the first body portion and the second body portion to rotate along a predetermined axis.

5. The mobile device case of claim 4, wherein the first connection portion connects the first body portion and the second body portion at a predetermined distance, and the distance changes as the first body portion and the second body portion rotate.

6. The mobile device case of claim 4, wherein the predetermined axis is located in a space between the first body portion and the second body portion.

7. The mobile device case of claim 4, wherein the first body portion and the second body portion rotate according to a degree of bending of the first connection plug.

8. The mobile device case of claim 4, wherein the first connection plug is made of an elastic material and is capable of bending and returning to its original state.

9. The mobile device case of claim 1, wherein the first connection portion is connected through the first side hole located at one end of the first body portion and the second side hole located at one end of the second body portion.

10. The mobile device case of claim 1, further comprising:
a second connection portion including a third insertion plug detachable and attachable to a third side hole located on a second side of the first body portion and a fourth insertion plug detachable and attachable to a fourth side hole located on a second side of the second body portion, and a second connection plug connecting the third insertion plug and the fourth insertion plug.
